(19) United States
(12) Patent Application Publication
(10) Pub. No.: US 2019/0132443 A1
(43) Pub. Date: May 2, 2019

(54) DEVICES AND METHODS FOR FACILITATING TRAINING AND QUALITY ASSURANCE IN CONTACT CENTERS

(71) Applicant: PERFECT PITCH TECHNOLOGY, LLC, Lehi, UT (US)

(72) Inventors: Jacob Munns, Salt Lake City, UT (US); Greg Doermann, Eagle Mountain, UT (US)

(21) Appl. No.: 15/800,015

(22) Filed: Oct. 31, 2017

(51) Int. Cl. H04M 3/22; G06Q 10/06; G06Q 10/10

(52) U.S. Cl. CPC H04M 3/2227; G06Q 10/06398; G09B 7/00; G06Q 10/10; H04M 3/2254

(57) ABSTRACT

Contact management servers are adapted to facilitate training and quality assurance of agents working in contact centers. According to at least one example, a contact management server may transmit a first prerecorded prospect audio segment. A first transmission may be received, where the first transmission indicates a keypress by a call center agent in response to the transmitted first prerecorded prospect audio segment. The contact management server can grade the keypress indicated by the first transmission. Other aspects, embodiments, and features are also included.

### TECHNICAL FIELD

The technology discussed below relates generally to telemarketing call systems, and more specifically to methods and devices for facilitating automated training and quality control for call center agents.

### BACKGROUND

Customer contact centers are utilized in many different and diverse organizations for exchanging information between the enterprise and customers. Customer contact centers, which may also be referred to as call centers, have emerged as one of the most important and dynamic areas of a successful business strategy. In many enterprises, contact centers represent a main interfacing point between a client and the enterprise, handling incoming and outgoing calls from and to its clients in support of its operations. For example, telemarketing businesses utilize contact centers to make outgoing calls to market and sell the company's products. Service and products businesses utilize contact centers for a variety of purposes including dispatch of account information to a client, maintenance of the company's goods or services, and tracking of product shipments by clients. Contact centers are additionally utilized as an effective method for informational collection for polling and research oriented organizations, such as by conducting surveys.

Advancements in contact center technology may be desirable to further improve the customer experience when interacting with a contact center.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Various examples and implementations of the present disclosure facilitate training and quality assurance of agents working in contact centers utilizing prerecorded agent audio scripts. One or more embodiments of the present disclosure include contact management servers. According to at least one example, a contact management server may include a communications interface and a storage medium coupled to a processing circuit. The storage medium may include a plurality of prerecorded prospect audio segments. The processing circuit may include logic configured to transmit a first prerecorded prospect audio segment via the communications interface, receive a first transmission indicating a keypress by a call center agent in response to the transmitted first prerecorded prospect audio segment, and grade the keypress indicated by the first transmission.

Additional aspects of the present disclosure include methods operational on a contact management server. In at least one example, such methods may include transmitting a first prerecorded prospect audio segment, and receiving a first transmission indicating a keypress by a call center agent in response to the transmitted first prerecorded prospect audio segment. The keypress indicated by the first transmission may further be scored.

Further aspects of the present disclosure include non-transitory processor-readable storage mediums storing processor-executable programming. According to at least one example, the processor-executable programming may be configured to cause a processing circuit to transmit a first prerecorded prospect audio segment. The processor-executable programming may further be configured to cause a processing circuit to receive a first transmission indicating a keypress by a call center agent in response to the transmitted first prerecorded prospect audio segment, and to grade the keypress indicated by the first transmission.

Other aspects, features, and embodiments associated with the present disclosure will become apparent to those of ordinary skill in the art upon reviewing the following description in conjunction with the accompanying figures.

### DRAWINGS

FIG. 1 is a block diagram of a network environment in which one or more aspects of the present disclosure may find application.

FIG. 2 is a schematic block diagram illustrating select components of a contact management system according to at least one example.

FIG. 3 is a flow diagram illustrating a simplified example of a segment of a pitch according to at least one example.

FIG. 4 is a block diagram illustrating select components of a contact management server employing a processing system according to at least one example of the present disclosure.

FIG. 5 is a flow diagram illustrating a method operational on a contact management server according to at least one example.

FIG. 6 is a flow diagram depicting at least some operations of a contact management server operating in a training mode according to at least one example.

FIG. 7, consisting of FIGS. 7A and 7B, is a flow diagram depicting at least some operations of a contact management server operating in a live mode according to at least one example.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

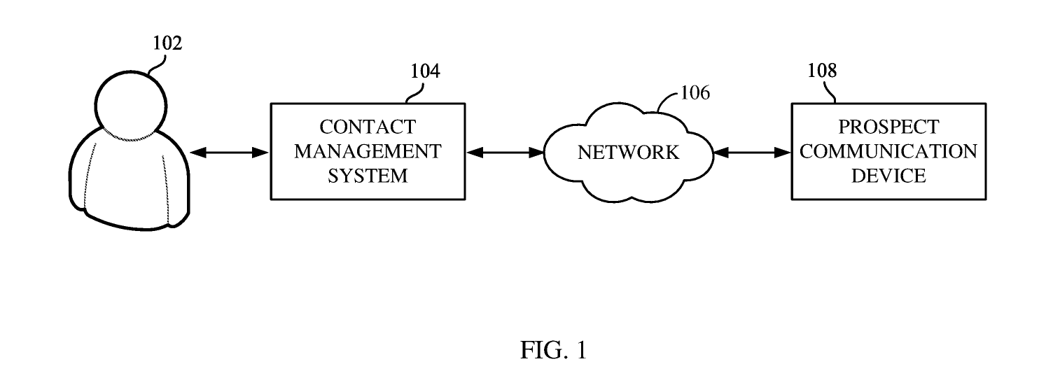

Referring now to FIG. 1, a block diagram of a network environment in which one or more aspects of the present disclosure may find application is illustrated. Aspects of the present disclosure can be employed in systems adapted to facilitate the management of inbound and outbound calls between an agent at a contact center and a prospect over a communication network. More specifically, an agent 102 may interact with a contact management system 104 to select one or more prerecorded audio segments or scripts (referred to herein as prerecorded scripts) to be played over a communication network 106 to a prospect communication device 108, where each selected prerecorded script can be audibly played to a prospect.

The agent 102 may interact with the contact management system 104 by interacting directly with a processing system to select the prerecorded scripts stored on the processing system, or by interacting with an agent work station that is communicatively connected to a contact management server where prerecorded scripts are stored and played over the communications network 106.

The communications network 106 can include digital and/or analog communication capabilities for telephony and internet connections, as are generally known in the art. The prospect communication device 108 may be any one of a number of known communication devices 108 configured to communicate with the contact management system 104 such as cellular devices, satellite devices, computer-based communication applications, broadband-based devices, and/or VOIP devices.

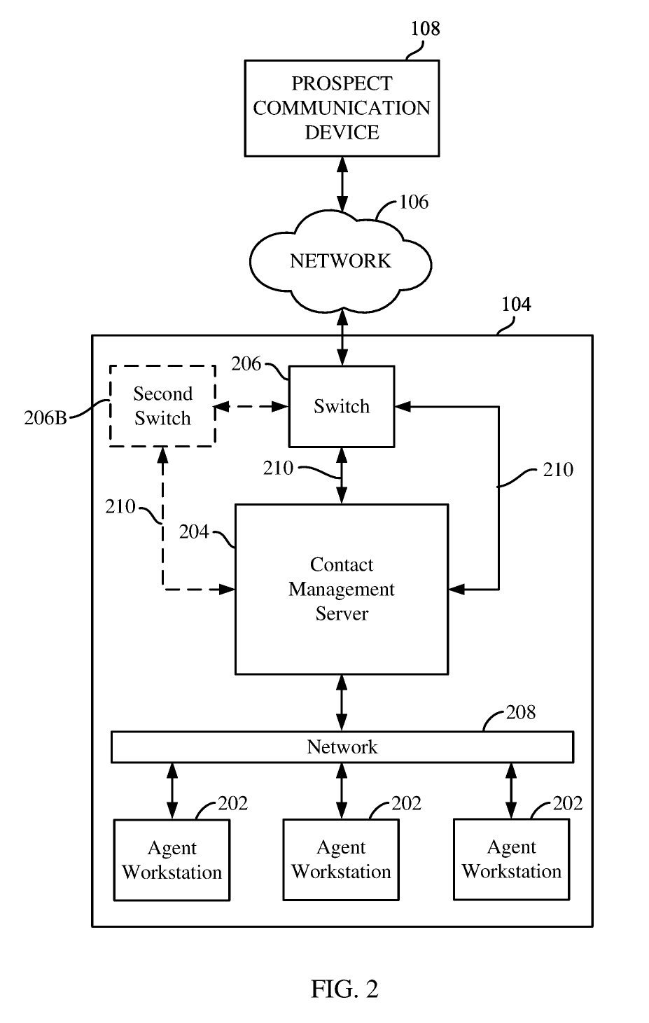

Referring to FIG. 2, a block diagram illustrating select components of the contact management system 104 is depicted according to at least one example. In this example, the agent 102 interacts with the contact management system 104 by interacting with an agent work station 202 that is communicatively connected to a contact management server 204 where prerecorded scripts are stored and played over the communications network 106.

Agent workstations 202 may be general-purpose digital computers comprising resident programing to provide desired functions of each agent workstation 202. In one embodiment, the agent workstations 202 are personal computers equipped with memory, hard drive, input devices (e.g., a keyboard, mouse, microphone, headphones), and a visual display unit. In some embodiments, a first audio channel may be directed to the left speaker in a set of headphones to broadcast audio associated with a first call, while a second audio channel to the right speaker in the headphones may broadcast audio associated with a second call. In this way, the agent may listen to two conversations simultaneously.

As depicted, the agent workstations 202 may be communicatively connected to a network (e.g., Wide Area Network (WAN), Local Area Network (LAN)) 208 to communicate with the contact management server 204. The contact management server 204 can be connected to at least one switch 206 configured to connect the contact management server 204 with the communications network 106. The communications network 106 typically connects a prospect communication device 108 to the contact management server 204 via at least one switch 206. The telephony switch 206 can be controllable by the contact management server 204, which may be configured to make, break or change connections between telephone lines in order to establish, terminate, or change a telephone call path. The switch 206 can be a Private Branch Exchange (PBX) switch and may be one of any number of known switches. The switch 206 is preferably configured to provide network information such as ANI (answer number identification, also known as Caller Line Identification (CLI)) and DNI (dialed number identification). In one embodiment, the switch 206 is configured to perform intelligent dialing functions and to transfer calls as requested by the contact management server 204. In at least some embodiments, the switch 206 can be implemented in one or more stand-alone devices signally connected to the contact management server 204. In one or more other embodiments, the switch 206 may be implemented in software and/or hardware in the contact management server 204.

Generally speaking, the contact management server 204 manages functional aspects of the contact management system 104, including managing one or more databases, managing interactions between the caller, the contact management system 104, and the agent workstations 202, and monitoring and controlling the switch 206. The contact management server 204 may include an inbound call manager to connect calls to an agent-operator if one is available, and send the call to a voicemail recorder otherwise. The contact management server 204 may be configured to log operational statistics of the switch 206, such as call duration, receiver connection address, and caller connection address. The contact management server 204 may provide administrative access and tools to manage, monitor, and create prerecorded scripts. The contact management server 204 may be configured to manage predetermined administrative functions, such as user accounts and SIP settings. The contact management server 204 may also provide a number of reporting tools for monitoring the agent-operators and dialer performance, and access to prerecorded scripts.

During a typical call with a prospect, the agent 102 is presented a pitch associated with a particular campaign being performed by a contact center. A pitch will include a plurality of prerecorded scripts to be utilized by an agent 102 to conduct a call with a prospect. Each pitch may be depicted in a flow diagram based on typical and expected statements that a prospect may make at any given time during a pitch.

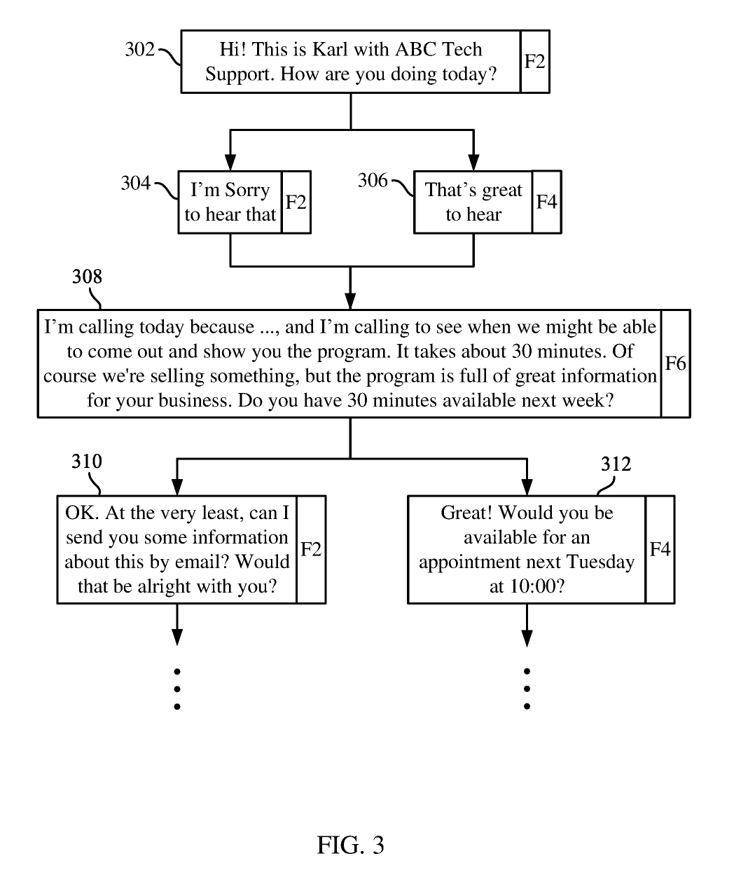

FIG. 3 is a flow diagram illustrating a simplified example of a segment of a pitch according to at least one example. In the example, there may be additional scripts that are played before the first depicted script. This is an example of an outbound call, but it will be apparent to those of ordinary skill in the art that similar calls may be received as inbound calls at the contact center. Further, specific computer keyboard keys are referenced in this example, but it will be apparent to those of ordinary skill in the art that any keyboard key or combination of keys may be utilized in different embodiments. Referring to FIGS. 2 and 3, a prospect may be contacted and an agent may select a key on the agent workstation 202 to play the prerecorded script 302 to the prospect. As shown in this example, the key F2 can be associated with this prerecorded script at this stage in the campaign so that when the agent presses F2, the prerecorded script 302 is played to the prospect.

After the prerecorded script 302 is played to the prospect, new script options may be displayed to the agent, based on expected responses. For instance, prerecorded script 304 may be available to the agent for instances when the prospect may respond with a negative answer, and prerecorded script 306 may be available to the agent for instances when the prospect may responds with a positive answer. In this example, the key F2 may now be associated with the prerecorded script 304 and the key F4 may be associated with the prerecorded script 306. The agent can accordingly press either F2 to play the prerecorded script 304 to the prospect or F4 to play the prerecorded script 306 to the prospect. Upon pressing a particular key at the agent workstation 202, a signal is sent to the contact management server 204 indicating the particular key pressed by the agent, and the associated prerecorded script is conveyed over the network 106 to the prospect communication device 108. In at least some implementations, the audio may also be conveyed back to the agent to enable the agent to hear the audio played to the prospect.

After playing a response script, a new script may be displayed to the agent. In this example, only one prerecorded script 308 is displayed at this point in the pitch. The agent can therefore select prerecorded script 308 to be played to the prospect, or it may be set to play automatically after a response is played by either of prerecorded scripts 304, 306. In this example, the key associated with prerecorded script 308 is F6. When the agent presses the F6 key, the prerecorded script 308 is conveyed over the network 106 to the prospect.

After the prerecorded script 308 is conveyed to the prospect, new script options may be displayed to the agent, based on expected responses. For instance, prerecorded script 310 may be available to the agent for instances when the prospect responds with a negative answer, and prerecorded script 312 may be available to the agent for instances when the prospect responds with a positive answer. In this example, the F2 key may now be associated with the prerecorded script 310 and the key F4 may be associated with the prerecorded script 312. The agent can accordingly press either F2 to play prerecorded script 310 to the prospect, or F4 to play prerecorded script 312 to the prospect. Upon pressing a particular key at the agent workstation 202, a signal is sent to the contact management server 204 indicating the particular key pressed by the agent, and the associated prerecorded script is conveyed over the network 106 to the prospect communication device 108.

The script may continue forward in a similar manner, with the agent selecting prerecorded scripts to be played to the prospect. Throughout this conversation, the agent may also have access to global prerecorded script options that can be played at any time by pressing an associated key. For example, prerecorded global scripts may include “yes,” “no,” a laugh, “uh huh,” “okay,” “I understand,” “I'm sorry,” “could you repeat that,” “great,” as well as additional and/or other prerecorded scripts options.

Agents must be proficient with the selection of prerecorded scripts and global prerecorded scripts to facilitate a conversational feel that sounds to the prospect like the prospect is listening to, and communicating with a real person instead of prerecorded scripts. According to one or more aspects of the present disclosure, a training system is included to perform automated training and testing of agents. For example, the training system of the present disclosure can be utilized to train new agents in conducting calls with prospects by utilizing prerecorded audio for the prospect side of the conversation. Additionally, the training system of the present disclosure can be utilized to test agents actively calling prospects by conducting test calls with the agent using similar prerecorded prospect audio in place of an actual live prospect.

In at least one example of the present disclosure, such training systems can be implemented by the contact management server 204. Referring back to FIG. 2, the contact management server 204 may be connected to the one or more switches 206 through a plurality of communication channels 210. With more than one communication channel 210 to one or more switches 206, the contact management server 204 can convey test calls to agents either in a training capacity or in a quality assurance capacity by conveying prerecorded audio of a prospect to an agent. The contact management server 204 is further configured to monitor the agent's performance during such a test call, and to quantify or grade the agent's proficiency in utilizing the system in a manner desired by the contact center.

In at least some embodiments, the contact management server 204 can include one or more communications channels 210 to a first switch 206, and a call can be routed by the first switch 206 to a second switch 206B that also includes one or more communication channels 210 to the contact management server 204. Such an example is depicted in FIG. 2 by the components and connections depicted in broken lines to illustrate the optional aspects of this configuration. In this example, a test call can be routed from the agent workstation 202 through the contact management server 204 to the first switch 206. The call is then routed from the first switch 206 to the second switch 206B, and back to the contact management server 204 that is conveying the prerecorded prospect audio.

Although the example described herein includes a training system implemented by the contact management server 204, it should be apparent to those of ordinary skill in the art that other embodiments may implement a training system of the present disclosure as one or more separate components configured in a manner to convey audio to an agent through a switch 206. Additionally, aspects of the present disclosure can be carried out with more than one contact management server 204, where a call can be routed from an agent workstation 202 through a contact management server 204 to a first switch 206, and the first switch 206 routes the call to a second switch 206 that is connected with another contact management server 204 that sends the prerecorded prospect audio.

Those of ordinary skill in the art will recognize that other configurations may be utilized to achieve the same functionality for training and testing agents with prerecorded prospect audio, as set forth herein.

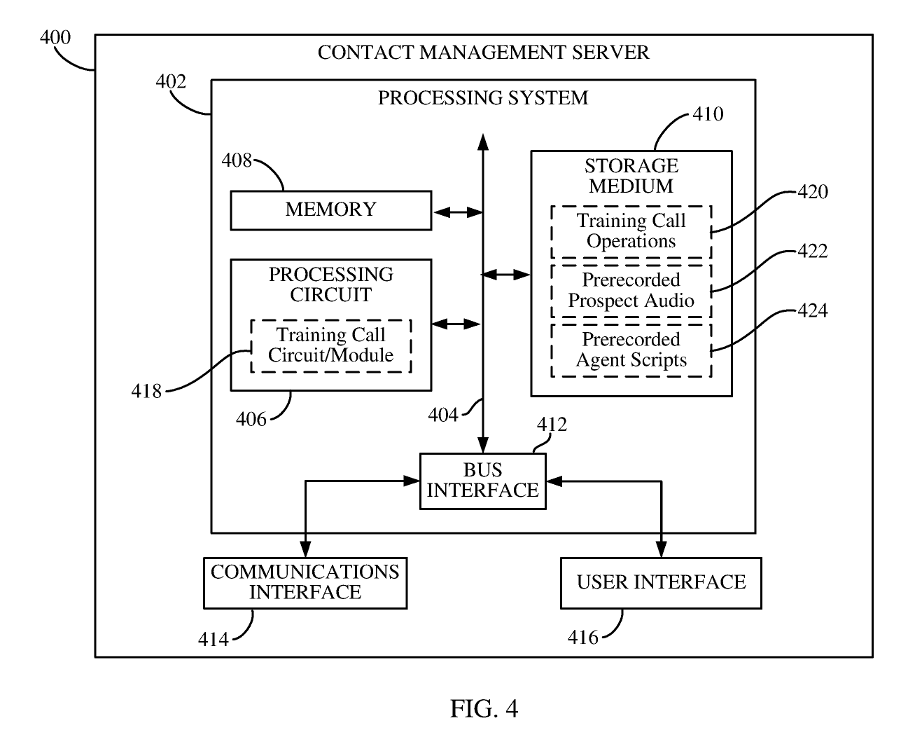

Turning to FIG. 4, a block diagram is shown illustrating select components of contact management server 400 employing a processing system 402 according to at least one example of the present disclosure. In this example, the processing system 402 is implemented with a bus architecture, represented generally by the bus 404, although other embodiments may alternatively be implemented by a distributed system. The bus 404 may include any number of interconnecting buses and bridges depending on the specific application of the processing system 402 and the overall design constraints. The bus 404 communicatively couples together various circuits including one or more processors (represented generally by the processing circuit 406), a memory 408, and computer-readable media (represented generally by the storage medium 410). The bus 404 may also link various other circuits such as timing sources, peripherals, voltage regulators, and power management circuits, which are well known in the art, and therefore, will not be described any further. A bus interface 412 provides an interface between the bus 404 and a communications interface 414. The communications interface 414 provides a communication interface or means for communicating with various other apparatus over a transmission medium. Depending upon the nature of the contact management server, a user interface 416 (e.g., keypad, display, speaker, microphone, joystick) may also be provided.

The processing circuit 406 is responsible for managing the bus 404 and general processing, including the execution of programming stored on the computer-readable storage medium 410. The programming, when executed by the processing circuit 406, causes the processing system 402 to perform the various functions described below for any particular apparatus. The computer-readable storage medium 410 and the memory 408 may also be used for storing data that is manipulated by the processing circuit 406 when executing programming. As used herein, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The processing circuit 406 is arranged to obtain, process and/or send data, control data access and storage, issue commands, and control other desired operations. The processing circuit 406 may include circuitry adapted to implement desired programming provided by appropriate media, and/or circuitry adapted to perform one or more functions described in this disclosure. For example, the processing circuit 406 may be implemented as one or more processors, one or more controllers, and/or other structure configured to execute executable programming and/or execute specific functions. Examples of the processing circuit 406 may include a general purpose processor, a digital signal processor (DSP), an application specific integrated circuit (ASIC), a field programmable gate array (FPGA) and/or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 406 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 406 are for illustration and other suitable configurations within the scope of the present disclosure are also contemplated.

In some instances, the processing circuit 406 may include a training call circuit and/or module 418. The training call circuit/module 418 may generally include circuitry and/or programming (e.g., programming stored on the storage medium 410) adapted to conduct a training or test call with an agent or a trainee, using prerecorded prospect audio segments and determining a grade for each response from the agent as indicated in more detail below. As used herein, reference to circuitry and/or programming may be generally referred to as logic (e.g., logic gates and/or data structure logic).

The storage medium 410 may represent one or more computer-readable devices for storing programming, such as processor executable code or instructions (e.g., software, firmware), electronic data, databases, or other digital information. The storage medium 410 may also be used for storing data that is manipulated by the processing circuit 406 when executing programming. The storage medium 410 may be any available non-transitory media that can be accessed by a general purpose or special purpose processor, including portable or fixed storage devices, optical storage devices, and various other mediums capable of storing, containing and/or carrying programming. By way of example and not limitation, the storage medium 410 may include a non-transitory computer-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 410 may be coupled to the processing circuit 406 such that the processing circuit 406 can read information from, and write information to, the storage medium 410. That is, the storage medium 410 can be coupled to the processing circuit 406 so that the storage medium 410 is at least accessible by the processing circuit 406, including examples where the storage medium 410 is integral to the processing circuit 406 and/or examples where the storage medium 410 is separate from the processing circuit 406 (e.g., resident in the processing system 402, external to the processing system 402, distributed across multiple entities).

Programming stored by the storage medium 410, when executed by the processing circuit 406, can cause the processing circuit 406 to perform one or more of the various functions and/or process steps described herein. In at least some examples, the storage medium 410 may include training call operations 420, as well as prerecorded prospect audio 422, and optionally prerecorded agent scripts 424. The training call operation 420 are generally adapted to cause the processing circuit 406 to conduct a training or test call with an agent or a trainee, using prerecorded prospect audio segments and determining a grade for each response from the agent as indicated in more detail below. The prerecorded prospect audio 422 can include a plurality of prerecorded prospect audio segments that can be played to sound like a prospect with whom the agent is communicating. The prerecorded agent scripts 424, when present on the contact management server 400, may include a plurality of prerecorded agent script segments/audio that are typically played for a prospect in response to keypresses by the agent.

Thus, according to one or more aspects of the present disclosure, the processing circuit 406 is adapted to perform (independently or in conjunction with the storage medium 410) any or all of the processes, functions, steps and/or routines for any or all training system devices described herein (e.g., contact management server 204, contact management server 400). As used herein, the term “adapted” in relation to the processing circuit 406 may refer to the processing circuit 406 being one or more of configured, employed, implemented, and/or programmed (in conjunction with the storage medium 410) to perform a particular process, function, step and/or routine according to various features described herein.

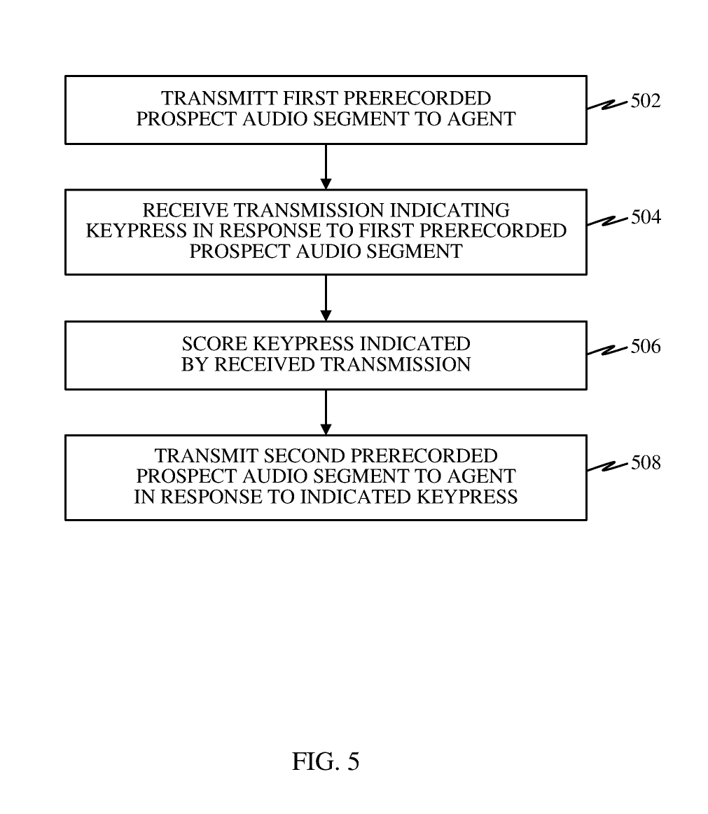

FIG. 5 is a flow diagram illustrating at least one example of a method operational on a contact management server, such as the contact management server 400. Referring to FIGS. 2, 4, and 5, a contact management server 400 can transmit a first prerecorded prospect audio segment to an agent at 502. For example, the contact management server 400 may include logic (e.g., training call circuit/module 418 and/or training call operations 420) to transmit the first prerecorded prospect audio segment over the communications interface 414. In at least one implementation, the logic (e.g., training call circuit/module 418 and/or training call operations 420) may play the audio associated with the first prerecorded prospect audio segment through the communications interface such that the agent will be able to hear the audio. As noted above, in one or more embodiments the prerecorded prospect audio segment may be transmitted from the contact management server 400 to a switch 206, from which the prerecorded prospect audio segment can be conveyed to an agent workstation 202.

In some implementations, it should be noted that an introductory agent audio segment may be utilized prior to the transmission of the first prerecorded prospect audio segment. The following examples, however, will be presented from a point of time after such an introductory audio segment is transmitted, when utilized.

At 504, the contact management server 400 can receive a transmission indicating one or more keypresses by the agent in response to the first prerecorded prospect audio segment. The one or more keypresses may be associated with a prerecorded agent script 424 and/or a disposition for a call. A disposition refers to how to handle that prospect for future contact, such as putting the contact on a do-not-contact list, “call back later,” “can't afford now,” etc. In at least one implementation, the contact management server 400 may include logic (e.g., training call circuit/module 418 and/or training call operations 420) to receive the transmission via the communications interface 414, where the received transmission indicates the one or more keypresses.

In embodiments where a keypress indicated by the received transmission is associated with a prerecorded agent script 424, the contact management server 400 may include logic (e.g., training call circuit/module 418 and/or training call operations 420) to play the respective prerecorded agent script 424 via the communications interface 414 so the agent can hear the selected prerecorded agent script played to what the agent might assume to be a prospect.

At 506, the contact management server 400 can score the keypress indicated by the received transmission. For example, the contact management server 400 may include logic (e.g., training call circuit/module 418 and/or training call operations 420) to score/grade the keypress indicated by the received transmission. In at least one embodiment, the logic may be configured to apply a predetermined value to the keypress. For example, at different points or nodes of the test, each possible keypress can be assigned a value, depending on how appropriate the specific keypress is at that particular point in the test. For instance, in the example in FIG. 3, a prerecorded prospect audio segment may be played to respond to the first prerecorded agent script segment 302 with audio saying “not you guys again—put me on your do-not-call list and stop calling me.” In response to such a statement, the prerecorded agent script segment 304 may be okay stating “I'm sorry to hear that,” but a more appropriate response might be use of a global option that simply states “I'm sorry,” which could be followed with one or more other global options that indicate the prospects addition to a do-not-call list. In such an example, the prerecorded agent script segment 304 may be assigned a specific value indicating the keypress of F2 as an acceptable keypress, and the global option of “I'm sorry” may be assigned a specific value indicating the global option keypress as the preferred keypress at this point in the call.

Although not all disposition keypresses may be unassociated with a prerecorded agent script segment, when the keypress is a disposition keypress that is not associated with any prerecorded agent script segment, the grade can be saved and the test may continue or be completed. On the other hand, when the key press is associated with a specific prerecorded agent script segment (e.g., non-disposition keypresses, some disposition keypresses), the contact management server 400 may transmit to the agent a second prerecorded prospect audio segment in response to the indicated keypress at 508. For example, the contact management server 400 may include logic (e.g., training call circuit/module 418 and/or training call operations 420) to select a prerecorded prospect audio segment that has been predetermined for playing in response to the keypress indicated.

This method may continue with additional received transmissions indicating keypresses, grading the indicated keypresses, and transmitting prerecorded prospect audio segments in response to indicated keypresses. Additional aspects that may be considered by the contact management server 400 in grading a test call may include whether one or more keypresses interrupted a prospect audio segment when it was being played, how an agent responds to a prospect audio segment that interrupts the agent script segment when being played, which keypresses occur, if any, during extended periods of silence from the prospect, etc. For example, an agent interrupting a prospect when the prospect is talking may not be desired, and a lower grade may accordingly be assigned for a segment where there is a keypress for an agent audio segment while the prospect audio is still being played. Additionally, the prospect audio may be programmed to interrupt the agent audio segment to determine how the agent reacts to such situations. Further, a relatively long period of silence from the prospect side of a call may be employed to determine whether the agent selects an agent audio segment that would be natural with a live person, such as by way of example an agent audio segment that says something like, “hello, can you hear me?” The contact management server 400 may also be configured to obtain heuristics about connection quality and transmission delays that can be factored into the grading. It should be clear that other criteria may also be considered and included in one or more test calls as selected by a call center to test agents on one or more particular skills desired by agents utilizing the contact management systems described herein.

When a test call is completed, the contact management server 400 can generate a report including the grade for the keypresses, the time periods between playing of prospect audio segments and receiving a transmission indicating a keypress, and/or any other additional information the test center identifies as being relevant. Such a report may include grading based on a consideration of all of the grades/scores for the entire call. Such an overall grade may indicate whether an active agent needs to be re-trained or reprimanded. Such an overall grade may also indicate whether a training agent is prepared to handle live calls, needs additional training, or other action by the employer.

The above method may be implemented by the contact management server 400 operating in one or both of a training mode and/or a live mode. The training mode may be employed to train new agents in the efficient use of the prerecorded script systems, or to train experienced agents in a new pitch implemented by the prerecorded script systems of the present disclosure. The live mode may be utilized to test agents who are actively conducting calls with live prospects, but whom the contact center may want to test periodically to ensure quality levels for each agent.

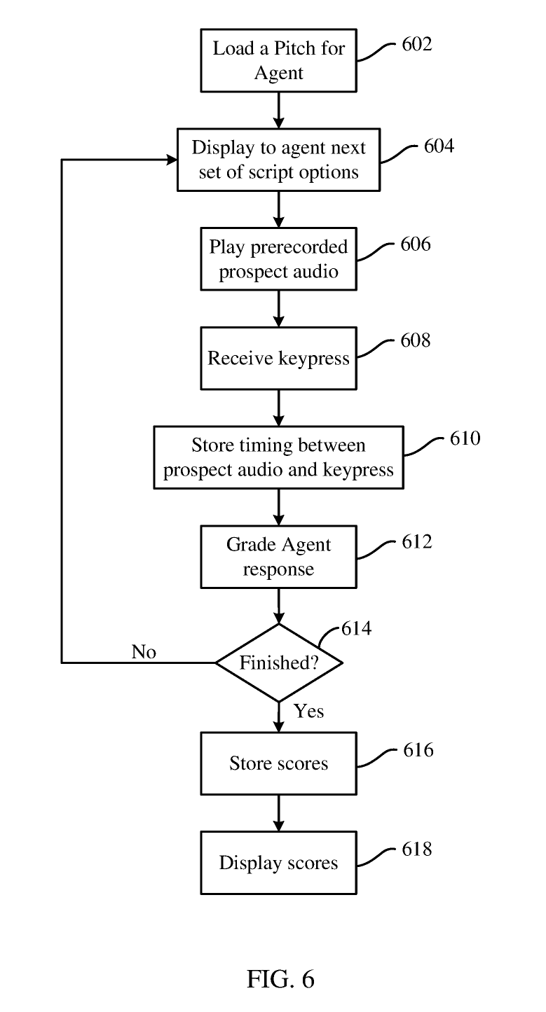

FIG. 6 is a flow diagram depicting at least some operations of a contact management server 400 in training mode according to at least one example. As shown at operation 602, a pitch may be loaded for the agent to practice. In at least one embodiment, the contact management server 400 may load the pitch for display at the agent workstation 202.

At operation 604, the next set of script options may be displayed for the agent at the agent workstation 202. For example, the contact management server 400 may include logic (e.g., training call circuit/module 418 and/or training call operations 420) to display one or more script options at the agent workstation 202. Referring to FIG. 3, the contact management server 400 may include logic (e.g., training call circuit/module 418 and/or training call operations 420) to display the first prerecorded agent script segment 302 at the agent workstation 202.

At operation 606, the contact management server 400 can play a prerecorded prospect audio segment to the agent. For instance, the contact management server 400 may include logic, as described above, for transmitting a prerecorded prospect audio segment to the agent.

At operation 608, the contact management server 400 may receive a keypress. That is, the contact management server 400 may include logic, as described above, for receiving a transmission indicating a specific keypress.

At operation 610, the contact management server 400 can store the timing between the end of the prerecorded prospect audio segment played to the agent and the keypress selected by the agent.

At operation 612, the contact management server 400 can grade the agent response. That is, the contact management server 400 can include logic to apply a predetermined score to the specific keypress from the agent. The grade may also take into account the timing determined at operation 610. Additional aspects that may be considered for the grading may include long delays by the agent, interruptions by the agent, and/or other aspects the contact center may determine to be important for determining agent proficiency.

At decision diamond 614, a determination is made whether the training call is completed. If the call is not completed, then the process can return to operation 604, where the next set of script options are displayed to the agent at the agent workstation 202. On the other hand, if the call is complete, the contact management server 400 can store the scores from operation 610 for each keypress at operation 616, and can display the scores at the agent workstation 202 at operation 618. In addition, a report can be generated for each agent, which can be provided to a trainer and/or the agent for immediate feedback. A trainer can receive a group of results that can rank the different agents, such as to indicate agents that are ready to go to live mode, agents that need more training, and/or agents that are unable to operate the system.

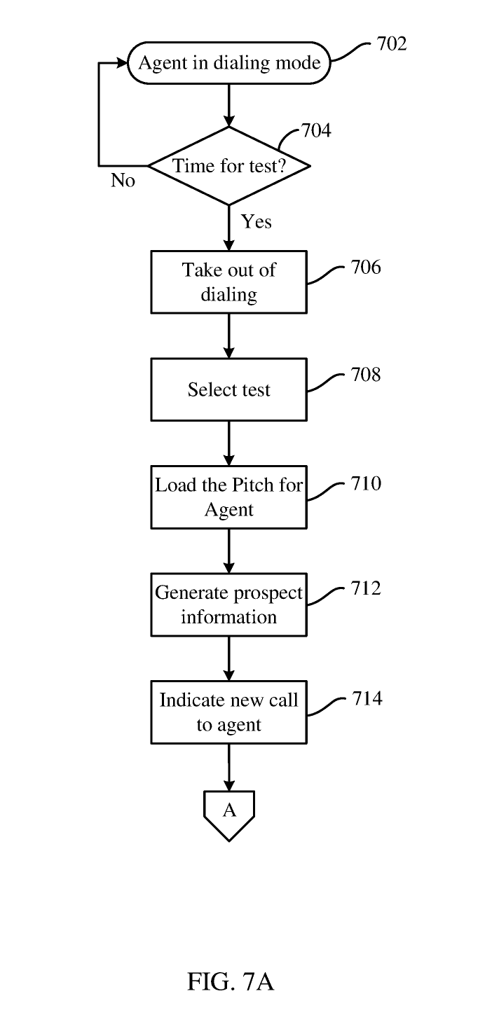

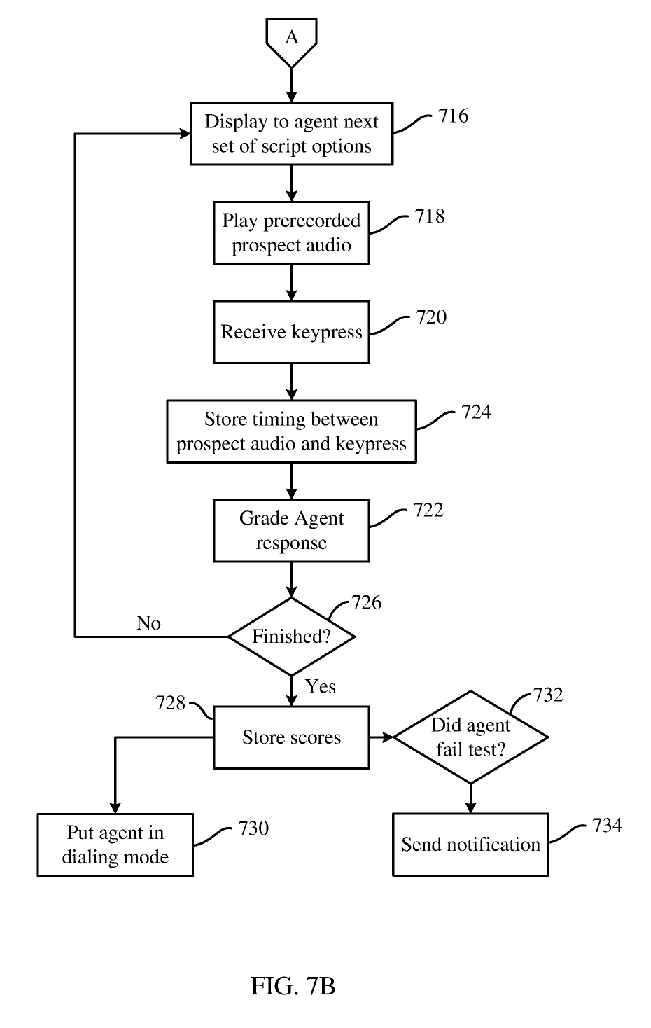

FIG. 7, including FIG. 7A and FIG. 7B, is a flow diagram depicting at least some operations of a contact management server 400 in live mode according to at least one example. As shown at 702, the agent to be tested may be in a dialing mode. That is, the agent workstation 202 may be actively receiving and/or making phone calls to prospects.

At decision diamond 704, a determination is made whether to test the agent. In some implementations, a system may be set up where each agent is tested at a predetermined rate, such as every X minutes, or Y times per minute. If it is determined that it is not time for the agent to be tested, then the agent remains in dialing mode at 702, and continues to conduct calls with prospects. On the other hand, if it is determined to be time for the agent to be tested, then the agent can be removed from dialing at operation 706. For example, the contact management server 400 may include logic (e.g., training call circuit/module 418 and/or training call operations 420) to remove the agent from the dialer so that the agent no longer is connected to live persons who are either called by the contact center or who have called the contact center.

At operation 708 a test may be selected. In some implementations, the contact management server 400 may randomly select a test. In some implementations, the specific tests may be selected based on one or more particular skills that the contact center wants to be tested. In some instances, the contact management server 400 may select a test that will not alter the agent's statistics with live calls. For example, the contact management server 400 may only select a test that does not end with a customer verifying a purchase of a product, since such a test would cause the agent to assume they successfully completed a sell when in reality the call was only a test and no sell was actually completed. Instead, the test may be selected with a prerecorded prospect audio that requests an action such as removal from a call list or other similar action that does not result in a successful or failed attempt to accomplish a goal of the particular call campaign.

At operation 710, the selected pitch may be loaded for the agent to be tested. In at least one embodiment, the contact management server 400 may load the pitch for display at the agent workstation 202. In addition, the contact management server 400 may generate information about the prospect with whom the agent believes they are communicating at operation 712.

At operation 714, contact management server 400 may indicate a new call to the agent. Such an indication may indicate a new call received or a new call made, and serves to notify the agent that it is time to conduct an active call with a prospect. The indication may include displaying the prospect information to the agent, a sound played to the agent, and/or another signal, as well as any other suitable indication or combination of indications.

The process of FIG. 7 continues on FIG. 7B at operation 716, where the next set of script options may be displayed for the agent at the agent workstation 202. For example, the contact management server 400 may include logic (e.g., training call circuit/module 418 and/or training call operations 420) to display one or more script options at the agent workstation 202.

At operation 718, the contact management server 400 can play a prerecorded prospect audio segment to the agent. For instance, the contact management server 400 may include logic, as described above, for transmitting a prerecorded prospect audio segment to the agent.

At operation 720, the contact management server 400 may receive a keypress. That is, the contact management server 400 may include logic, as described above, for receiving a transmission indicating a specific keypress.

At operation 722, the contact management server 400 can store the timing between the end of the prerecorded prospect audio segment played to the agent and the keypress selected by the agent.

At operation 724, the contact management server 400 can grade the agent response. That is, the contact management server 400 can include logic to apply a predetermined score to the specific keypress from the agent. The grade may also take into account the timing determined at operation 722. Additional aspects that may be considered for the grading may include long delays by the agent, interruptions by the agent, and/or other aspects the contact center may determine to be important for determining agent proficiency.

At decision diamond 726, a determination is made whether the training call is completed. If the call is not completed, then the process can return to operation 716, where the next set of script options are displayed to the agent at the agent workstation 202. On the other hand, if the call is complete, the contact management server 400 can store the scores from operation 722 for each keypress at operation 728, and can return the agent back in the dialing mode at operation 730.

In addition, an analysis can be made to the scores to determine whether the agent failed the test at decision diamond 732. For example, the contact management server 400 can include logic to compare the scores for each of the individual keypresses to determine whether the overall call was above or below some predetermined threshold for a successful call for that particular test. If the total scores are below a threshold, the contact management server 400 can include logic to send a notification at operation 734 to one or more persons. For example, the contact management server 400 can include logic to send an email, a short message service (SMS) message, or other notification to a supervisor or other personnel who can determine if the agent who failed the test should be removed from live mode, terminated, re-trained, or otherwise dealt with. The supervisor can then go in and do a manual test, review the failed test, or listen to the test to determine what happened.

Aspects described herein for contact management servers 400 can provide systems capable of automatically playing prerecorded prospect audio segments to test an agent in training modes or in live modes, without the need of human intervention to perform such evaluations. As a result, relatively large numbers of contact center employees can be trained and/or evaluated in a timely manner without supervisor or trainee evaluations. A contact center utilizing one or more of these features can determine whether new agents are ready to enter live mode, need more training, or should be let go. Additionally, a contact center utilizing one or more of these features can evaluate the quality of agents in live mode on a regular basis, and problems can be reported as necessary, without human intervention.

Details of a call, such as delay by the agent, pressing wrong keys, setting wrong dispositions, etc. can be graded to determine an agent's efficacy with the prerecorded call script systems described herein. In addition, the contact management servers described herein may retain full audio recordings of a call that can be reviewed to obtain a full understanding of what happened on any test call. In a training setting, a trainer can pull up examples of a good call and/or a bad call to be played a whole training group without exposing any specific agent for a bad call when the prerecorded agent scripts are not in the agent's own voice.

Further, the various tests can utilize numerous different voices and accents for the prerecorded prospect audio. In this way, the system can test various aspects of the agents' competency to understand diverse groups of people and situations. Additionally, multiple different voices enable the features described herein to be utilized without agents recognizing when they are being tested. In some examples, the prerecorded prospect audio may be taken from actual calls that were conducted in live mode, where the prospect audio is saved and then utilized as prerecorded prospect audio for the present disclosure.

Although the above disclosure specifically refers to keypresses, it should be understood that a keypress may be a keypress from a keyboard, as well as selection of a graphical “key” on a touchscreen device, selection of a graphical “key” with a mouse, or other similar ways for selecting an audio segment to be played to a prospect. Accordingly, the term “keypress” should be understood to include all of these examples and other similar examples for selecting an audio script segment to be played.

While the above discussed aspects, arrangements, and embodiments are discussed with specific details and particularity, one or more of the components, steps, features and/or functions illustrated in FIGS. 1, 2, 3, 4, 5, 6 and/or 7 may be rearranged and/or combined into a single component, step, feature or function or embodied in several components, steps, or functions. Additional elements, components, steps, and/or functions may also be added or not utilized without departing from the present disclosure. The apparatus, devices and/or components illustrated in FIGS. 1, 2, and/or 4 may be configured to perform or employ one or more of the methods, features, parameters, and/or steps described in FIGS. 3, 5, 6, and/or 7. The novel algorithms described herein may also be efficiently implemented in software and/or embedded in hardware.

While features of the present disclosure may have been discussed relative to certain embodiments and figures, all embodiments of the present disclosure can include one or more of the advantageous features discussed herein. In other words, while one or more embodiments may have been discussed as having certain advantageous features, one or more of such features may also be used in accordance with any of the various embodiments discussed herein. In similar fashion, while exemplary embodiments may have been discussed herein as device, system, or method embodiments, it should be understood that such exemplary embodiments can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. A contact management server, comprising:
a communications interface;
a storage medium storing a plurality of prerecorded prospect audio segments; and
a processing circuit coupled to the communications interface and the storage medium, wherein the processing circuit comprises logic to:
transmit a first prerecorded prospect audio segment via the communications interface;
receive a first transmission indicating a keypress by a call center agent in response to the transmitted first prerecorded prospect audio segment; and
grade the keypress indicated by the first transmission.

2. The contact management server of claim 1, wherein:
the storage medium further includes a plurality of prerecorded agent script segments stored thereon;
the keypress indicated by the received first transmission is associated with a prerecorded agent script segment stored by the storage medium; and
the processing circuit further comprises logic to transmit the prerecorded agent script segment via the communications interface in response to the indicated keypress.

3. The contact management server of claim 1, wherein:
the keypress indicated by the received first transmission is associated with a prerecorded agent script segment; and
the processing circuit further comprises logic to transmit a second prerecorded prospect audio segment responsive to the prerecorded agent script segment associated with the keypress indicated by the received first transmission.

4. The contact management server of claim 3, wherein the processing circuit further comprises logic to:
receive a second transmission indicating a keypress by the call center agent in response to the transmitted second prerecorded prospect audio segment; and
grade the keypress indicated by the second transmission.

5. The contact management server of claim 1, wherein the processing circuit comprising logic to grade the keypress indicated by the first transmission comprises the processing circuit comprising logic to:
apply a predetermined value to the keypress; and
determine an amount of time between the transmission of the first prerecorded prospect audio segment and receipt of the first transmission indicating the keypress.

6. The contact management server of claim 1, wherein the keypress indicated by the received first transmission is associated with a disposition.

7. The contact management server of claim 1, wherein the processing circuit further comprises logic to:
generate a report including the grade for the keypress indicated by the first transmission; and
transmit the report via the communications interface to a predetermined person or group of persons.

8. A method operational on a contact management server, comprising:
transmitting a first prerecorded prospect audio segment;
receiving a first transmission indicating a keypress by a call center agent in response to the transmitted first prerecorded prospect audio segment; and
scoring the keypress indicated by the first transmission.

9. The method of claim 8, wherein the keypress indicated by the received first transmission is associated with a prerecorded agent script segment.

10. The method of claim 9, further comprising:
transmitting the prerecorded agent script segment in response to the indicated keypress.

11. The method of claim 9, further comprising:
transmitting a second prerecorded prospect audio segment responsive to the prerecorded agent script segment associated with the keypress indicated by the received first transmission.

12. The method of claim 11, further comprising:
receiving a second transmission indicating a keypress by the call center agent in response to the transmitted second prerecorded prospect audio segment; and
scoring the keypress indicated by the second transmission.

13. The method of claim 8, wherein scoring the keypress indicated by the first transmission comprises:
applying a predetermined value to the respective keypress.

14. The method of claim 8, wherein the keypress indicated by the received first transmission is associated with a disposition.

15. The method of claim 8, further comprising:
generating a report including the grade for the keypress indicated by the first transmission; and
transmitting the report to a predetermined person or group of persons.

16. A non-transitory processor-readable storage medium storing processor-executable programming for causing a processing circuit to:
transmit a first prerecorded prospect audio segment;
receive a first transmission indicating a keypress by a call center agent in response to the transmitted first prerecorded prospect audio segment; and
grade the keypress indicated by the first transmission.

17. The processor-readable storage medium of claim 16, wherein the keypress indicated by the received first transmission is associated with a prerecorded agent script segment, and further comprising processor-executable programming for causing a processing circuit to:
transmit a second prerecorded prospect audio segment responsive to the prerecorded agent script segment associated with the keypress indicated by the received first transmission.

18. The processor-readable storage medium of claim 17, further comprising processor-executable programming for causing a processing circuit to:
receive a second transmission indicating a keypress by the call center agent in response to the transmitted second prerecorded prospect audio segment; and
grade the keypress indicated by the second transmission.

19. The processor-readable storage medium of claim 16, wherein the processor-executable programming for causing a processing circuit to grade the keypress indicated by the first transmission comprises processor-executable programming for causing a processing circuit to:
apply a predetermined value to the keypress; and
determine an amount of time between the transmission of the first prerecorded prospect audio segment and receipt of the first transmission indicating the keypress.

20. The processor-readable storage medium of claim 16, further comprising processor-executable programming for causing a processing circuit to:
generate a report including the grade for the keypress indicated by the first transmission and a time interval between the transmission of the first prerecorded prospect audio segment and receipt of the first transmission indicating the keypress; and
transmit the report to a predetermined person or group of persons.
